(19) United States
(12) Patent Application Publication
(10) Pub. No.: US 2012/0060287 A1
(43) Pub. Date: Mar. 15, 2012

(54) SUPPORT DEVICE WHICH IS ADJUSTABLE BY AN ELECTRIC MOTOR

(75) Inventors: Eckhart Dewert, Goldingen (CH); Jörg Henle, Giebelstadt-Allersheim (DE)

(73) Assignee: Bionical Systems AG, Zurich (CH)

(21) Appl. No.: 13/275,056

(22) Filed: Oct. 17, 2011

Related U.S. Application Data
(63) Continuation of application No. PCT/EP2010/002088, filed on Mar. 31, 2010.

(30) Foreign Application Priority Data
Apr. 17, 2009 (DE) 10 2009 017 894.5

(51) Int. Cl. A61G 7/002

(52) U.S. Cl. 5/600

(57) ABSTRACT

Support device is adjustable by an electric motor, for supporting cushioning of a piece of furniture for sitting and/or lying on, and has a base body with a first support part that is adjustable, in particular pivotable, with respect to a second support part. Support device has an electric motor adjusting device connected with first support part for adjusting it. Adjusting device has a first and a second adjusting unit second adjusting unit which are provided on opposite longitudinal sides of base body. A rotationally supported component of the first adjusting unit is connected in rotationally fixed manner to a similar component of the second adjusting unit via a connecting shaft, and a shared electric motor is associated with the adjusting units. The rotationally supported component in each case is an input-side transmission element of a reduction gear.

### CROSS-REFERENCE TO RELATED APPLICATIONS

This application is a continuation of application no. PCT/EP2010/002088, filed Mar. 31, 2010, which claims the priority of German application no. 10 2009 017 894.5, filed Apr. 17, 2009, and each of which is incorporated herein by reference.

### FIELD OF THE INVENTION

The invention relates to a support device, which is adjustable by an electric motor, for supporting a cushioning of a piece of furniture for sitting and/or lying on, in particular a bed mattress.

### BACKGROUND OF THE INVENTION

Such support devices for cushioning of items of furniture for sitting and/or lying on, for example in the form of slatted frames, are generally known, for example from EP 0 372 032 B2, DE 38 42 078 C2, DE 199 62 541 C3, and DE 100 46 751 A1.

A support device, which is adjustable by an electric motor, of the type in question for supporting cushioning of an item of furniture for sitting and/or lying on, in particular a bed mattress, is known from DE 10 2004 016 048 A1, comprising a base body which has a first support part that is adjustable, in particular pivotable, relative to a second support part. The known support device also has an electric motor adjusting device which is in operative connection with the first support part for adjusting same. In the known support device, the adjusting device has a first adjusting unit and a second adjusting unit which are situated on opposite longitudinal sides of the base body, and a rotationally supported component of the first adjusting unit is connected in an essentially rotationally fixed manner to a similar component of the second adjusting unit via a connecting shaft, and a shared electric motor is associated with the adjusting units. In the support device known from the cited document, the components which are connected to one another in an essentially rotationally fixed manner via the connecting shaft are pivot shafts which are in operative connection with the first support part for pivoting same. The support device known from the cited document is designed in such a way that an electric motor is associated with an adjusting unit, the drive torque of the electric motor being transmitted to the second adjusting unit via the connecting shaft. The drive torque of the electric motor which in each case is converted into an adjustment force via a spindle drive is thus introduced into oppositely situated longitudinal sides of a first support part, via the first adjusting unit on the one hand and the second adjusting unit on the other hand, so that both adjusting units are in mechanical forced synchronization with one another. This avoids the situation that the longitudinal sides of the support part are lifted to different degrees during an adjusting motion, which could result in twisting of the first support part.

### OBJECTS AND SUMMARY OF THE INVENTION

An object of the invention is to provide a support device, which is adjustable by an electric motor, for supporting cushioning of a piece of furniture for sitting and/or lying on, in particular a bed mattress, having a simplified and therefore more cost-effective configuration.

This object is achieved by the invention as set forth herein.

More particularly, the invention includes a support device, which is adjustable by an electric motor, for supporting cushioning of a piece of furniture for one of sitting and lying on, which includes:
a) a base body which has a first support part that is adjustable, in particular pivotable, with respect to a second support part;
b) an electric motor adjusting device which is operatively connected with the first support part for adjusting same;
c) the electric motor adjusting device having a first adjusting unit and a second adjusting unit which are situated on opposite longitudinal sides of the base body;
d) a rotationally supported component of the first adjusting unit being connected in an essentially rotationally fixed manner to a similar component of the second adjusting unit via a connecting shaft;
e) a shared electric motor being associated with the adjusting units; and
f) the respective rotationally supported component includes an input-side transmission element of a reduction gear.

The invention is based on the knowledge that the connecting shaft in the known support device is subjected to a significant torsional moment. To avoid undesirable torsion, which could result in the longitudinal sides of the first support part being lifted to different degrees during the adjustment, in the known support device it is necessary to use a connecting shaft having a large cross section.

On this basis, the invention is based on the concept of connecting components of the adjusting units, which are rotatably supported via the connecting shaft, in essentially a rotationally fixed manner, the components in each case being an input-side transmission element of a reduction gear. Whereas in the known support device, the rotatably supported components are coupled to one another in a rotationally fixed manner at a location on the drive train of the adjusting device at which the drive torque of the electric motor is already reduced by means of the reduction gear, i.e., a relatively large torque is to be transmitted, according to the invention the rotationally fixed connection between the rotatably supported components occurs at a location on the drive train at which the torque has not yet been converted, i.e., at a location on the drive train at which the torque is relatively low. Thus, according to the invention the conversion of the drive torque by the reduction gear occurs downstream from the essentially rotationally fixed coupling of the transmission elements to one another.

As a result, for the support device according to the invention the cross section of the connecting shaft may be greatly decreased without the risk of significant torsion of the connecting shaft. This simplifies the configuration of the support device, thus saving on costs. In addition, for the support device according to the invention the adjusting units may have a simpler configuration, thus likewise providing cost savings. This further reduces the manufacturing costs.

Another advantage of the support device according to the invention is that decreasing the cross section of the connecting shaft results in lower weight. This advantage is important in particular when the support device has more than one connecting shaft. For example, in addition to a connecting shaft which connects adjusting units associated with an upper body support part to one another, a further connecting shaft may be provided which connects adjusting units associated with a leg support part of a slatted frame to one another.

Another advantage of the support device according to the invention is that the freedom regarding the structural configuration of the adjusting units is increased.

The reduction gear may be any given suitable gearing, for example toothed gearing. In this regard, one advantageous further embodiment of the invention provides that the reduction gear is a worm gear. Suitable worm gears are available as relatively simple, inexpensive, and robust standard components.

One advantageous further embodiment of the above-described embodiment provides that the input-side transmission element is a worm of the worm gear. According to the invention, an input-side transmission element of the reduction gear is understood to mean a transmission element via which the drive torque of the electric motor is introduced into the reduction gear. In the above-described embodiment, the output-side transmission element of the worm gear is thus formed by the worm wheel. If the worm gear has multiple worm wheels which are engaged with a shared worm, each worm wheel forms an output-side transmission element within the meaning of the invention.

In the embodiments having the worm gear, however, the input-side transmission element may also be formed by a worm wheel, in which case the output-side transmission element is a worm. According to the invention, a reduction of the drive torque of the electric motor may achieved with only one reduction gear, whose input-side transmission element forms the rotatably supported component. However, according to the invention it is also possible to provide an additional reduction gear or multiple reduction gears downstream from this reduction gear if further reduction is desired or necessary.

To adjust, in particular pivot, the first support part relative to the second support part by means of a relatively simple structural construction, it is advantageous to convert the rotation of the output-side transmission element of the reduction gear into a linear motion of an output element which is in operative connection with the first support part for adjusting, in particular pivoting, same. In this regard, one advantageous further embodiment of the invention provides that the respective output-side transmission element of the reduction gear is connected in a rotationally fixed manner to a rotatably supported threaded spindle on which a spindle nut is situated in a rotationally fixed manner and axially movable corresponding to the rotational direction of the threaded spindle, the spindle nut forming the output element of the particular adjusting device. In this embodiment the adjusting units are configured as linear drives.

The invention is explained in greater detail below on the basis of one embodiment with reference to the accompanying drawings. All features that are described, illustrated in the drawings, and set forth in the claims constitute the subject matter of the invention, taken alone or in any given combination, independently of their combination in the claims and their dependencies, and independently of their description or illustration in the drawings.

Relative terms such as up, down, left, and right are for convenience only and are not intended to be limiting.

### BRIEF DESCRIPTION OF THE DRAWINGS

FIG. 1 shows a perspective view of one embodiment of a support device according to the invention in the form of a slatted frame, the slats of the slatted frame being omitted for the sake of clarity;

FIG. 2 shows a perspective view of a detail of a first adjusting unit of an adjusting device of the support device of the embodiment of FIG. 1; and

FIG. 3 shows, in the same manner as FIG. 2, a detail in the region of a second adjusting unit of the support device according to the invention.

### DETAILED DESCRIPTION OF THE INVENTION

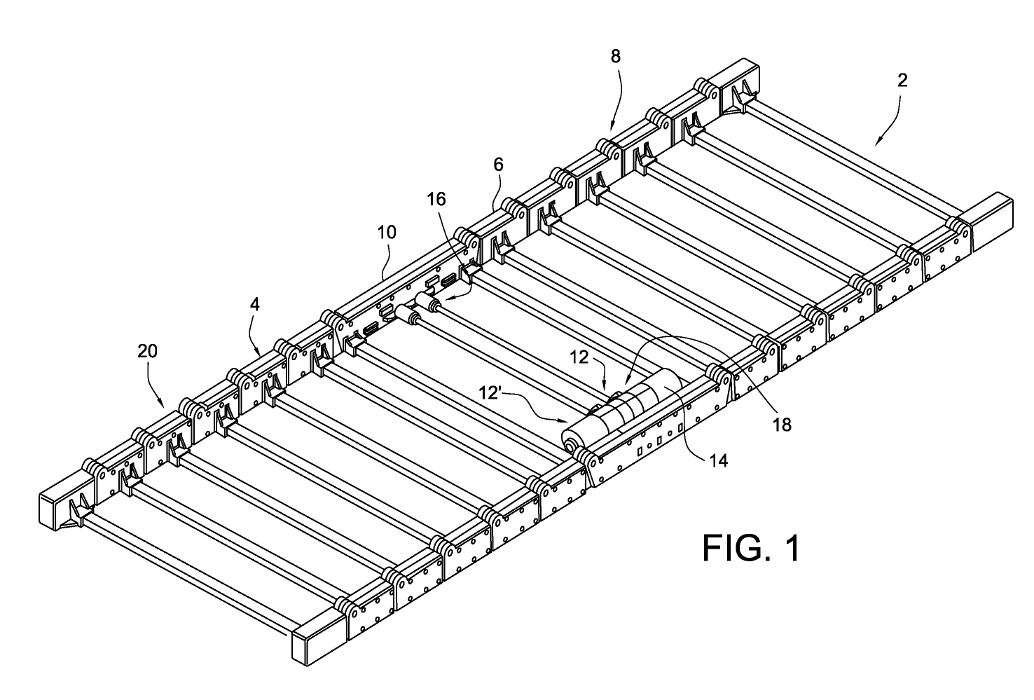

FIG. 1 illustrates an embodiment of a support device 2 according to the invention for supporting cushioning of a piece of furniture for sitting and/or lying on, configured as a slatted frame and used for supporting a bed mattress. In FIG. 1 the slats of the slatted frame as well as the mattress have been omitted in order to simplify the illustration for clarity. The support device 2 has a frame-like base body 4, having a first support part 6 which is part of an upper body support 8 composed of multiple support parts. The first support part 6 is adjustable relative to a second support part 10, in the illustrated embodiment the second support part 10 being formed by a stationary support part to which the first support part 6 is connected in an articulated manner so as to be pivotable about a horizontal pivot axis.

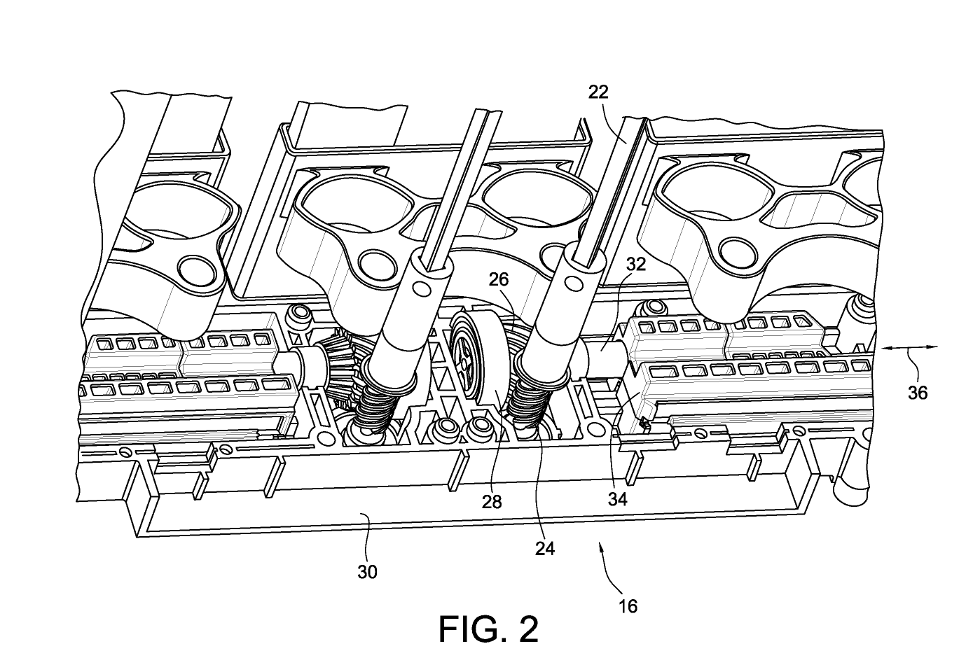

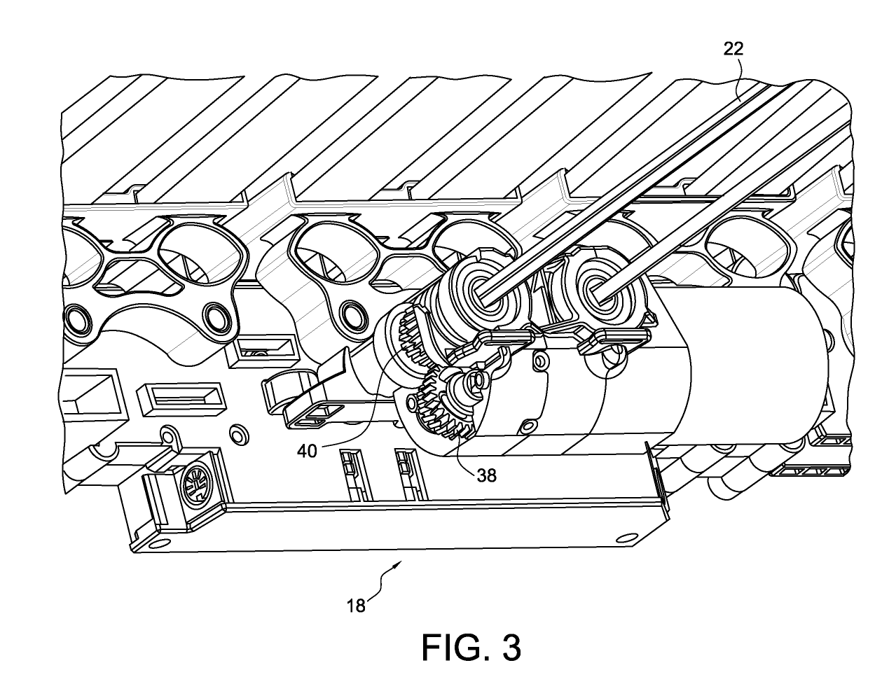

The support device 2 also has an electric motor adjusting device 12, which, in a manner explained in greater detail below with reference to FIG. 2 and FIG. 3, is in operative connection with the first support part 6 for adjusting same relative to the second support part 10. The electric motor adjusting device 12 has an electric motor 14 and a first adjusting unit 16, explained in greater detail below with reference to FIG. 2, and a second adjusting unit 18, explained in greater detail below with reference to FIG. 3.

For adjustment of a leg support 20 of the support device 2, an appropriate electric motor adjusting device 12′ is provided, which has a configuration corresponding to the electric motor adjusting device 12 and therefore is not explained in greater detail.

As is apparent from FIG. 1, the first adjusting unit 16 and the second adjusting unit 18 are provided at opposite longitudinal sides of the base body 4.

FIG. 2 shows a detail in the region of the first adjusting unit 16. The first adjusting unit 16 has a rotatably supported component which is connected in an essentially rotationally fixed manner to a similar component of the second adjusting unit 18 via a connecting shaft 22. According to the invention, each rotatably supported component is an input-side transmission element of a reduction gear, which in the present embodiment is configured as a worm gear whose worm 24 forms the input-side transmission element, while a worm wheel 26 which is engaged with the worm 24 forms an output-side transmission element of the worm gear 24, 26. The worm wheel 26 is supported in a housing 30 of the first adjusting unit 16 by means of a ball bearing 28. For purposes of illustration, the housing 30 of the first adjusting unit 16 is shown open in FIG. 2.

The worm wheel 26 is connected in a rotationally fixed manner to a rotatably supported threaded spindle 32, of which only an axial section is shown in FIG. 2 for purposes of illustration. A spindle nut 34 is provided in a rotationally fixed manner on the threaded spindle 32 and may be axially movable corresponding to the rotational direction of the threaded spindle 32, and forms the output element of the first adjusting unit 16. The spindle nut 34 is movable back and forth in the axial direction of the threaded spindle 32, in the direction of a double arrow 36, corresponding to the rotational direction of the threaded spindle 32. The rotational motion of the connecting shaft 22 is thus converted into a linear motion of the spindle nut 34 by means of the spindle drive which is formed by the spindle 32 and the spindle nut 34, so that a drive torque generated by the electric motor 14 is converted into an adjustment force which is introduced into the first support part 6. The manner in which a linear motion of the spindle nut 34 may be converted into a pivot motion of the first support part 6 relative to the second support part 10 is generally known to one skilled in the art, and therefore is not explained in greater detail here.

FIG. 3 shows a detail in the region of the second adjusting unit 18. The second adjusting unit 18 has a mirror-image configuration with respect to the first adjusting unit 16, and therefore is not explained in greater detail.

Thus, according to the invention, the worm 24 of the first adjusting unit 16 is connected in an essentially rotationally fixed manner to a corresponding worm of the second adjusting unit 18 via the connecting shaft 22.

A torque is introduced into the connecting shaft 22 via the electric motor 14, which for purposes of illustration has been omitted in FIG. 3. The output shaft of the electric motor 14 is in rotary drive connection with a first gear wheel 38 which is engaged with a second gear wheel 40 that is connected in a rotationally fixed manner to the connecting shaft 22, so that when the electric motor 14 is operating, the connecting shaft 22 is rotated corresponding to the rotational direction of the output shaft of the electric motor 14.

The operating principle of the support device 2 according to the invention is as follows:

For adjusting the first support part 6 relative to the second support part 10, the electric motor 14 is actuated, causing the connecting shaft 22 to rotate. Due to the essentially rotationally fixed connection between the worm 24 of the first adjusting unit 16 and the corresponding worm of the second adjusting unit 18, both worms are rotated essentially synchronously, so that the spindle nut 34 associated with the first adjusting unit 16 and the corresponding spindle nut associated with the second adjusting unit 18 move essentially synchronously. The spindle nuts conduct an adjustment force into oppositely situated longitudinal sides of the first support part 6, so that these longitudinal sides are lifted synchronously or essentially synchronously.

As a result of a reduction of the drive torque of the electric motor 14 at a location in the drive train downstream from the connecting shaft 22, namely, by means of the worm gear 24, 26 associated with the first adjusting unit 16 and the corresponding worm gear associated with the second adjusting unit 18, the connecting shaft 22 transmits a relatively small torque, so that the connecting shaft 22 may be configured with a relatively small cross section. According to the invention, an essentially rotationally fixed connection between similar rotatably supported components of the first adjusting unit and of the second adjusting unit is also understood to mean a connection which, due to torsion of the connecting shaft 22, is not completely rotationally fixed, provided that the torsion of the connecting shaft 22 does not result in significant trailing or leading of one of the longitudinal sides of the first support part 6 during the adjustment.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. Support device, which is adjustable by an electric motor, for supporting cushioning of a piece of furniture for one of sitting and lying on, comprising:
a) a base body having a first support part that is adjustable, in particular pivotable, with respect to a second support part;
b) an electric motor adjusting device being operatively connected with the first support part for adjusting same;
c) the electric motor adjusting device having a first adjusting unit and a second adjusting unit which are provided on opposite longitudinal sides of the base body;
d) a rotationally supported component of the first adjusting unit being connected in an essentially rotationally fixed manner to a similar component of the second adjusting unit via a connecting shaft;
e) a shared electric motor being associated with the adjusting units; and
f) the respective rotationally supported component including an input-side transmission element of a reduction gear.

2. Support device according to claim 1, wherein:
a) the reduction gear includes a worm gear.

3. Support device according to claim 2, wherein:
a) the input-side transmission element includes a worm of the worm gear.

4. Support device according to claim 1, wherein:
a) a respective output-side transmission element of the reduction gear is connected in a rotationally fixed manner to a rotatably supported threaded spindle on which a spindle nut is provided in a rotationally fixed manner and axially movable corresponding to the rotational direction of the threaded spindle, and which forms the output element of the respective adjusting device.

5. Support device according to claim 1, wherein:
a) the piece of furniture includes a bed mattress.
